(19) United States
(12) Patent Application Publication
(10) Pub. No.: US 2016/0196896 A1
(43) Pub. Date: Jul. 7, 2016

(54) MAIN BUS-BAR, A BRANCH BUS-BAR, A TRANSFER CONNECTOR AND A BUS-BAR ASSEMBLY

(71) Applicant: ABB Technology Ltd., Zurich (CH)

(72) Inventors: Changzhou Yang, Fujian (CN); Yang Zhang, Fujian (CN); Liqun Huang, Fujian (CN); Delong Wang, Fujian (CN); Xiaodong Liu, Fujian (CN); Congming Yan, Fujian (CN); Zhe Wang, Fujian (CN); Xin Zhang, Fujian (CN)

(21) Appl. No.: 15/067,822

(22) Filed: Mar. 11, 2016

Related U.S. Application Data
(63) Continuation of application No. PCT/CN2013/084643, filed on Sep. 29, 2013.

(51) Int. Cl. H01B 5/02

(52) U.S. Cl. CPC H01B 5/02

(57) ABSTRACT

Embodiments of the present disclosure disclose a main bus-bar. The main bus-bar consists of a first elongated flat portion and a second elongated flat portion. A longitudinal side of the first elongated flat portion and a longitudinal side of the second elongated flat portion are arranged to be joined with each other at a predetermined angle. The thickness of each of said the first elongated flat portion and the second elongated flat portion is non-uniform. With embodiments of the present disclosure, the skin effect and proximity effect caused by current carried in the main bus-bar can be reduced greatly. Embodiments of the present disclosure also disclose a transfer connector, a bus-bar assembly and a bus-bar system.

### FIELD OF THE INVENTION

Embodiments of the present disclosure generally relate to the filed of power products, and more particularly relate to a main bus-bar, a branch bus-bar, a transfer connector, and a bus-bar assembly.

### BACKGROUND OF THE INVENTION

Currently, a main bus-bar is widely used to transmit power from the outside power supply to various electrical components in a power distribution cabinet or a switchgear. A shape of a cross section of an existing main bus-bar is always hollowly rectangular or circular. Such a main bus-bar is always used in switching devices.

The rectangular bus-bar has a simple shape, and is easy to manufacture, but has poor mechanical bending strength. The amount of current carried by the rectangular bus-bar is also relatively small due to “skin effect” and “proximity effect” of the current. Moreover, the outside heat radiating surface of the rectangular bus-bar is small and not good enough to facilitate radiating of heat. When it is used as a large current bus-bar, relatively more materials and more space are needed. Additionally, there is a risk of point discharge due to the poor space electric field of the rectangular bus-bar.

The hollow circular bus-bar has a good mechanical bending strength, and materials for manufacturing it can be saved because of the hollow inside while the amount of current carried by such a bus-bar will not be affected. It can achieve a better space electric field than the above described rectangular bus-bar. However, the hollow circular bus-bar accompanies with remarkable inside heat accumulation. Since the inside heat radiating surface can not be sufficiently used, the temperature rising of certain key position within a power loop is probably to be increased.

Further, a branch bus-bar (sometimes referred to as tee-off device) is widely used to connect the main bus-bar to one of various electrical components in the power distribution cabinet. The existing branch bus-bar has a rectangular shape and consists of a first flat portion and a second flat portion. The second portion is joined with the first flat portion at one transverse end. In practices, the first portion is attached to a flat surface of the planar main bus-bar (e.g., the rectangular main bar-bus), and the second portion is fixed to a certain electrical component. However, due to the structure of the branch bus-bar, the branch bus-bar is only applicable to be attached to the planar main bus-bar.

### SUMMARY OF THE INVENTION

In view of the foregoing, It is therefore an objective of the present disclosure to provide a novel main bus-bar which can solve or at least partially mitigate at least a part of problems in the prior art.

A further objective of the present disclosure is to provide a novel bus-bar assembly comprising the above-mentioned novel main bus-bar.

Another objective of the present disclosure is to provide a novel transfer connector operable to connect the above-mentioned novel main bus-bar to a planar bus-bar.

According to a first aspect of the present disclosure, there is provided a main bus-bar. The main bus-bar consists of a first elongated flat portion and a second elongated flat portion, wherein a longitudinal side of the first elongated flat portion and a longitudinal side of the second elongated flat portion are arranged to be joined with each other at a predetermined certain angle. For simplicity, such a main bus-bar provided herein may be referred to as a V-shaped main bus-bar. A thickness of each of said first elongated flat portion or said second elongated flat portion may be non-uniform.

In an embodiment of the present disclosure, the thickness of each of the first elongated flat portion or the second elongated flat portion is gradually increased away from a joint area of said first elongated flat portion and said second elongated flat portion.

In another embodiment of the present disclosure, the thickness of each of the first elongated flat portion or the second elongated flat portion is gradually decreased away from a joint area of said first elongated flat portion and said second elongated flat portion.

In another embodiment of the present disclosure, the width of said first elongated flat portion may be equal to that of said second elongated flat portion.

In a further embodiment of the present disclosure, the other longitudinal side (27) of at least one of the first elongated flat portion and the second elongated flat portion, opposite to the joint area, is provided with a rounded flange. The thickness of the rounded flange is wider than the thickness of the rest of the respective elongated flat portion. Preferably, the rounded flange is provided with an internal groove.

In a further embodiment of the present disclosure, a longitudinal end of the first elongated flat portion and a longitudinal end of the second elongated flat portion are provided with one or more through-holes in which a thread is provided. Preferably, the thread is implemented by an embedded nut.

In a yet embodiment of the present disclosure, a longitudinal end of the first elongated flat portion and/or a longitudinal end of the second elongated flat portion are rounded.

In a yet embodiment of the present disclosure, the joint area formed between said first elongated flat portion and said second elongated flat portion is rounded.

In a yet embodiment of the present disclosure, a groove is provided at an end of the joint area formed between said first elongated flat portion and said second elongated flat portion.

In a yet embodiment of the present disclosure, a middle segment of said first elongated flat portion and/or said second elongated flat portion is coated with an electrical insulation composite.

According to a second aspect of the present disclosure, there is also provided a bus-bar assembly comprising: a main bus-bar consisting of a first elongated flat portion and a second elongated flat portion, wherein a longitudinal side of the first elongated flat portion and a longitudinal side of the second elongated flat portion are arranged to be joined with each other at a predetermined angle; and a branch bus-bar comprising one or more planar portions for connecting with an electrical component, and one or more bending segments extended from the planar portion. At least one of the elongated flat portions of the main bus-bar are arranged to be attached to the respective bending segments of the branch bus-bar.

In an embodiment of the present disclosure, a thickness of each of said first elongated flat portion and said second elongated flat portion is non-uniform. In particular, the thickness of each of said first elongated flat portion and said second elongated flat portion gradually increased or decreased away from a joint area of said first elongated flat portion and said second elongated flat portion.

In another embodiment of the present disclosure, the other longitudinal side of at least one of the first elongated flat portion and the second elongated flat portion, opposite to the joint area, is provided with a rounded flange. The thickness of the rounded flange is wider than that of the rest of the respective elongated flat portion.

In a yet embodiment of the present disclosure, a longitudinal end of the first elongated flat portion and/or a longitudinal end of the second elongated flat portion are provided with one or more first through-holes in which a thread is provided, and said bending segments are provided with one or more second embedded through-holes with a thread therein, and the respective elongated flat portion of the main bus-bar is arranged to be attached to the respective bending segment of the branch bus-bar via the respective first and second through-holes by means of a bolt structure.

According to a third aspect of the present disclosure, there is also provided a bus-bar system comprising two bus-bar assemblies as stated in the second aspect. At least one of the first elongated flat portion and the second elongated flat portion of the main bus-bar of the first bus-bar assembly is arranged to be parallel to respective one of the first elongated flat portion and the second elongated flat portion of the main bus-bar of the second bus-bar assembly.

According to a fourth aspect of the present disclosure, there is also provided a bus-bar assembly comprising: a main bus-bar consisting of a first elongated flat portion and a second elongated flat portion, wherein a longitudinal side of the first elongated flat portion and a longitudinal side of the second elongated flat portion are arranged to be joined with each other at a determined angle, a branch bus-bar comprising two or more planar portions, and a transfer connector for connecting the main bus-bar with the branch bus-bar. The transfer connector comprises a first connector elongated flat portion and a second connector elongated flat portion, a longitudinal side of the first connector elongated flat portion and a longitudinal side of the second connector elongated flat portion are arranged to be joined with each other at a predetermined angle, and one flat surface is provided between the first connector elongated flat portion and the second connector elongated flat portion. The first elongated flat portion of the main bus-bar is arranged to be attached to the first connector elongated flat portion. The second elongated flat portion of the main bus-bar is arranged to be attached to the second connector elongated flat portion. One of the two or more planar portions of the branch bus-bar is adapted to be connected to an electrical component, and the other of said two or more planar portions is arranged to be attached to the one flat surface.

In an embodiment of the present disclosure, a thickness of each of said first connector elongated flat portion and said second connector elongated flat portion is non-uniform.

In another embodiment of the present disclosure, said one flat surface is provided with one or more first embedded through-holes with a thread therein, and a side of said one or more first embedded through-holes opposite to said one flat surface is another flat surface.

Preferably, the thread is implemented by an embedded nut.

Preferably, the other flat surface is lower than a joint area of the first connector elongated flat portion and the second connector elongated flat portion.

Preferably, the other flat surface is formed as a surface for sank holes.

Preferably, the other flat surface is formed without damaging the joint area formed between said first connector elongated flat portion and said second connector elongated flat portion.

In a yet embodiment of the present disclosure, a longitudinal end of the first elongated flat portion and/or a longitudinal end of the second elongated flat portion are provided with one or more second embedded through-holes in which a thread is provided, and a longitudinal end of the first connector elongated flat portion and/or a longitudinal end of the second connector elongated flat portion are provided with one or more third embedded through-holes in which a thread is provided. The respective elongated flat portion of the main bus-bar is attached to the respective connector elongated flat portion of the transfer connector via the second and third embedded through-holes by means of a bolt structure.

In a yet embodiment of the present disclosure, the one flat surface is attached to the other portion of said two or more planar portions via said first through-holes and through-holes in the other portion by means of a bolt structure.

In a yet embodiment of the present disclosure, the joint area formed between said first connector elongated flat portion and said second connector elongated flat portion is rounded.

In a yet embodiment of the present disclosure, a longitudinal end of the first connector elongated flat portion and/or a longitudinal ends of the second connector elongated flat portion are rounded.

According to a fifth aspect of the present disclosure, there is also provided a bus-bar system comprising two bus-bar assemblies as stated in the fourth aspect. At least one of the first elongated flat portion and the second elongated flat portion of the main bus-bar of the first bus-bar assembly is arranged to be parallel to respective one of the first elongated flat portion and the second elongated flat portion of the main bus-bar of the second bus-bar assembly.

According to a sixth aspect of the present disclosure, there is also provided a transfer connector for connecting a main bus-bar with a branch bus-bar, comprising a first connector elongated flat portion and a second connector elongated flat portion. A longitudinal side of the first connector elongated flat portion and a longitudinal side of the second connector elongated flat portion are arranged to be joined with each other at a predetermined angle. The first connector elongated flat portion is adapted to be attached to a first elongated flat portion of a main bus-bar, and the second connector elongated flat portion is adapted to be attached to a second elongated flat portion of the main bus-bar. One flat surface is provided between the first connector elongated flat portion and the second connector elongated flat portion and is adapted to be attached to a branch bus-bar.

According to embodiments of the present disclosure, a V-shaped main bus-bar (although not accurate enough) is provided. Unlike the existing various planar main bus-bars, the inside radiating surface of the V-shaped main bus-bar can be sufficient used; and the V-shaped main bus-bar has a good space electric field and can avoid point discharge when used in pairs. In case of the same amount of current carried by main bus-bars, the V-shaped main bus-bar has the best mechanical bending strength and the best dynamic stability, and needs the minimum materials to manufacture, compared with, e.g., the above-mentioned rectangular bus-bar, hollow circular bus-bar.

According to embodiments of the present disclosure, it can also solve the challenge of using the new V-shape bus-bar with the existing flat surface branch bus-bar.

### BRIEF DESCRIPTION OF THE DRAWINGS

The above and other features of the present disclosure will become more apparent through detailed explanation on the embodiments as illustrated in the description with reference to the accompanying drawings, throughout which like reference numbers represent same or similar components and wherein:

FIGS. 1A and 1B schematically illustrate perspective views of two V-shaped main bus-bars according to embodiments of the present disclosure;

FIGS. 2A-2E schematically illustrate five side views of the V-shaped main bus-bars illustrated in FIGS. 1A and 1B;

FIGS. 3A-3E and 4A-4E schematically illustrate arrangements of a pair of the V-shaped main bus-bars illustrated in FIGS. 2A-2E;

FIG. 5 schematically illustrates perspective views of four branch bus-bars according to embodiments of the present disclosure;

FIG. 6 schematically illustrates a perspective view of a transfer connector according to an embodiment of the present disclosure;

FIG. 7 schematically illustrates perspective views of other transfer connectors according to embodiments of the present disclosure;

FIG. 8 schematically illustrates a perspective view of a unilateral attaching arrangement between a pair of V-shaped main bus-bar and a branch bus-bar, according to a embodiment of the present disclosure;

FIG. 9 schematically illustrates a side view of the attaching arrangement illustrated in FIG. 8;

FIG. 10 schematically illustrates a perspective view of another unilateral attaching arrangement between a V-shaped main bus-bar and a branch bus-bar, according to a embodiment of the present disclosure;

FIG. 11 schematically illustrates a side view of the attaching arrangement illustrated in FIG. 10;

FIG. 12 schematically illustrates a perspective view of a bilateral attaching arrangement between a V-shaped main bus-bar and a branch bus-bar, according to a embodiment of the present disclosure;

FIG. 13 schematically illustrates a side view of the attaching arrangement illustrated in FIG. 12;

FIG. 14 schematically illustrates a perspective view of a attaching arrangement using a transfer connector between a V-shaped main bus-bar and a branch bus-bar, according to a embodiment of the present disclosure; and

FIG. 15 schematically illustrates a side view of the attaching arrangement illustrated in FIG. 14.

### DETAILED DESCRIPTION OF EMBODIMENTS

Hereinafter, embodiments of the present disclosure will be explained in more details with reference to the above accompanying drawings. It should be appreciated that these embodiments are presented only to enable those skilled in the art to better understand and implement the present disclosure, not intended to limit the scope of the present disclosure in any manner.

Generally, all terms used in the claims are to be interpreted according to their ordinary meaning in the technical field, unless explicitly defined otherwise herein. All references to “a/an/the/said [element, device, component, means, step, etc]” are to be interpreted openly as referring to at least one instance of said element, device, component, means, unit, step, etc., without excluding a plurality of such devices, components, means, units, steps, etc., unless explicitly stated otherwise. Besides, the indefinite article “a/an” as used herein does not exclude a plurality of such steps, units, modules, devices, and objects, and etc.

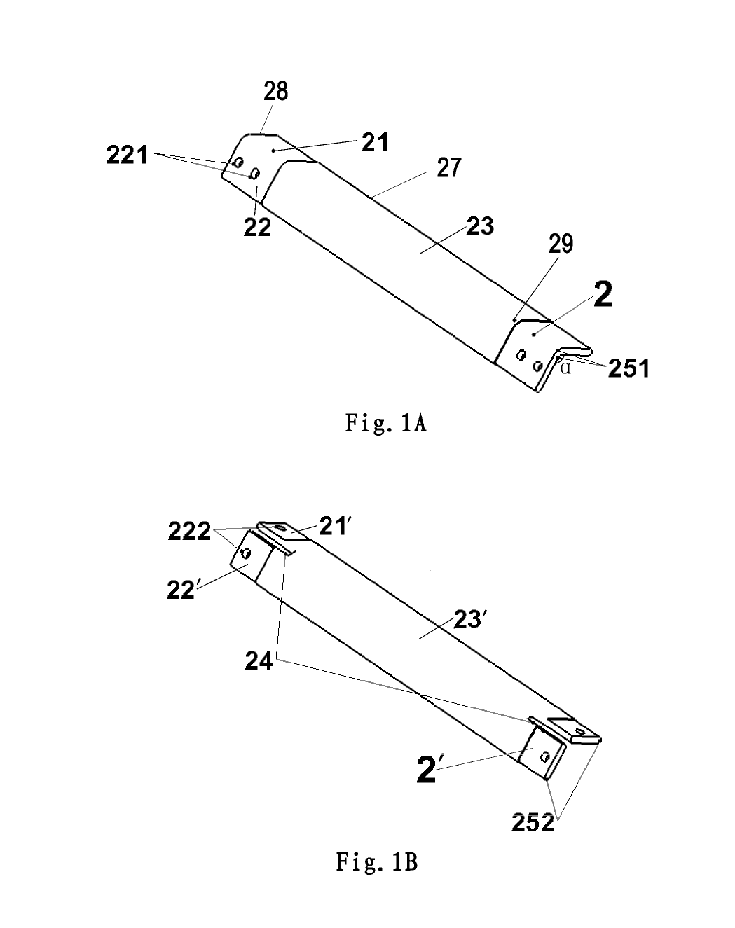

FIGS. 1A and 1B schematically illustrates perspective views of two V-shaped main bus-bars 2 and 2′ according to embodiments of the present disclosure.

In FIG. 1A, a main bus-bar 2 consists of a first elongated flat portion 21 and a second elongated flat portion 22. In FIG. 1B, a main bus-bar 2′ consists of a first elongated flat portion 21′ and a second elongated flat portion 22′ joined with each other. A longitudinal side of the first elongated flat portion 21 (or 21′) and a longitudinal side of the second elongated flat portion 22 (or 22′) are arranged to be joined with each other at a predetermined angle (a), with a joint area 29 being formed between the first elongated flat portion 21 and the second elongated flat portion 22. The joint area 29 includes an internal surface and an external surface, wherein the internal surface is formed by the joint of the internal surface of the first elongated flat portion 21 and the internal surface of the second elongated flat portion 22, and the external surface is formed by the joint of the external surface of the first elongated flat portion 21 and the external surface of the second elongated flat portion 22.

By way of an example, the angle α formed by the first elongated flat portion 21 (or 21′) and the second elongated flat portion 22 (or 22′), i.e., the angle between the internal (or external) surface of the first elongated flat portion and the internal (or external) surface of the second elongated flat portion, is shown as an obtuse angle in FIGS. 1A and 1B. However, as will be appreciated by those skilled in the art, the first elongated flat portion 21 (or 21′) and the second elongated flat portion 22 (or 22′) could also be joined at any other suitable angles, e.g. a right angle or a sharp angle.

In implementations, the V-shaped main bus-bars 2 or 2′ may be manufactured by bending, casting, molding and any other appropriate mechanical manufacture methods.

In an embodiment, when the main bus-bar 2 (2′) illustrated in FIG. 1A (or 1B) is utilized to transmit power from a power supply to a component in a power distribution cabinet (not shown), it can be connected with the power supply at one end of the elongated flat portions 21 (or 21′) and 22 (22′) and connected with a branch bus-bar at the other end of the elongated flat portions 21 (or 21′) and 22 (22′) for connecting to an electrical component.

Preferably, the main bus-bar 2 may be provided with several through-holes at end(s) of the elongated flat portions to make the fixing with the power supply or the electrical component more flexibly and easier, e.g., by means of a bolt structure. Optionally, a thread may be provided in every through-hole to improve the fixing strength. The through-holes are illustrated in FIGS. 1A and 1B as through-holes 221 and 222. It is to be noted that the position and the number of the through-holes depends on a particular implementation to obtain an appropriate fixing.

For example, in FIG. 1A, two holes 221 is positioned at one end of the elongated flat portion 22 but no holes at the opposite end of the elongated flat portion 21. In FIG. 1B, one hole 222 is positioned at one end of the elongated flat portion 21′ and another hole is positioned at one opposite end of the elongated flat portion 22′.

In a preferable embodiment, taking the main bus-bar 2 as an example, the joint area 29 between the first elongated flat portion 21 and the second elongated flat portion 22 may be rounded, as can be better seen from the end 251 of the joint area, in order to facilitate decreasing of the skin effect and the uniformity of the electric field, which are caused by the current carried in the main bus-bar 2.

In another preferable embodiment, taking the main bus-bar 2 as an example, a longitudinal end of the first elongated flat portion 21 and a longitudinal end of the second elongated flat portion 22, and/or a longitudinal side opposite to the joint area 29, may be rounded, in order to further facilitate the decreasing of the skin effect and the uniformity of the electric field, which are caused by the current carried in the main bus-bar.

In an embodiment, at least one end of the joint area 29 may be provided with a groove 24, in order to obtain a more closely attachment to a power supply or a branch bus-bar. Moreover, such a groove facilitates to compensate the manufacture tolerance of the main bus-bar and the branch bus-bar to be met.

In an embodiment, the middle segment of the V-shaped main bus-bar 2 may be coated with an electrical insulation composite 23, such as epoxy coating, to provide insulation protection to the main bus-bar. Compared to the existing insulation solutions with an insulation sleeve, the cost and volume of the V-shaped main bus-bar can be reduced due to the use of the electrical insulation composite. It will be appreciated that any other appreciate electrical insulation composite may be used to coat the V-shaped main bus-bar to provide insulation protection.

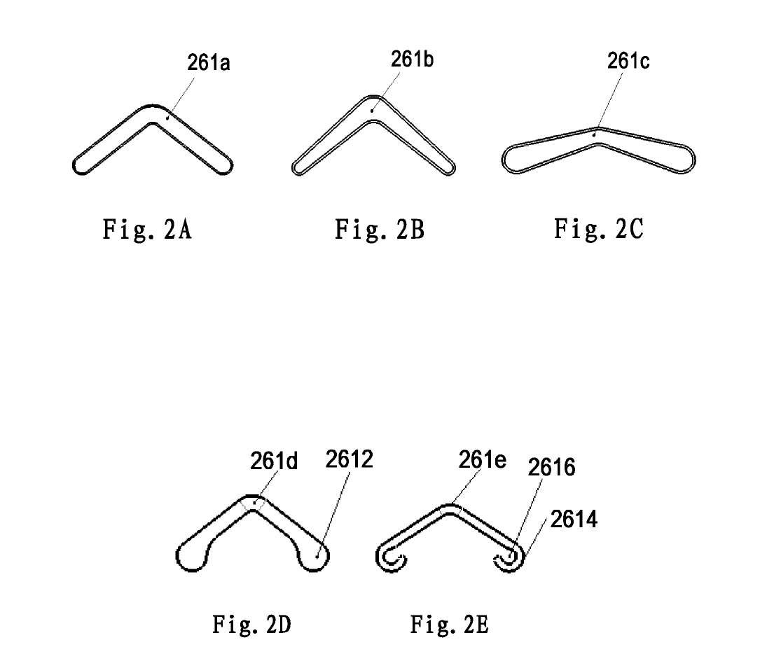

FIG. 2A schematically illustrates a cross section 261a of the V-shaped main bus-bar illustrated in FIGS. 1A and 1B. As can be seem from the cross section 261a in FIG. 2A, the thickness of the first elongated flat portion 21 and the second elongated flat portion 22 is uniform. This is an apparent implementation for the V-shaped main bus-bar. However, the thickness of the first elongated flat portion 21 or the second elongated flat portion 22 may be non-uniform; in particular, the said thickness besides the joint area 29 is non-uniform. Preferable embodiments of the cross section 261b-261e are provided herein, as shown in FIGS. 2B-2E.

In FIG. 2B, the thickness of the first elongated flat portion 21 and the second elongated flat portion 22 is gradually increased away from the joint area. That is, the thickness of the middle portion in the cross section is larger than that of ends in cross section 261b. Alternatively and conversely, in FIG. 2C, the thickness of the first elongated flat portion 21 or the second elongated flat portion 22 is gradually decreased away from the joint area.

In FIGS. 2D and 2E, the end of the first elongated flat portion and/or the second elongated flat portion, opposite to the joint area, is provided with a rounded flange 2612 (or 2614). In FIG. 2D, the thickness of the rounded flange is wider than the thickness of the other part of the elongated flat portions. In FIG. 2E, there is a groove 2616 in the rounded flange.

Advantageously, the skin effect and proximity effect of current carried in the V-shaped main bus-bar can be substantially reduced according to embodiments of FIGS. 2B-2E.

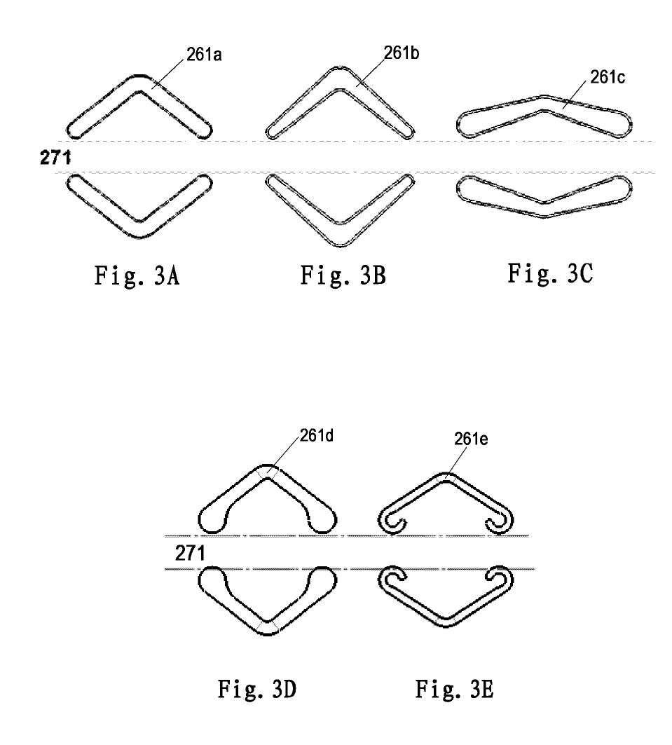

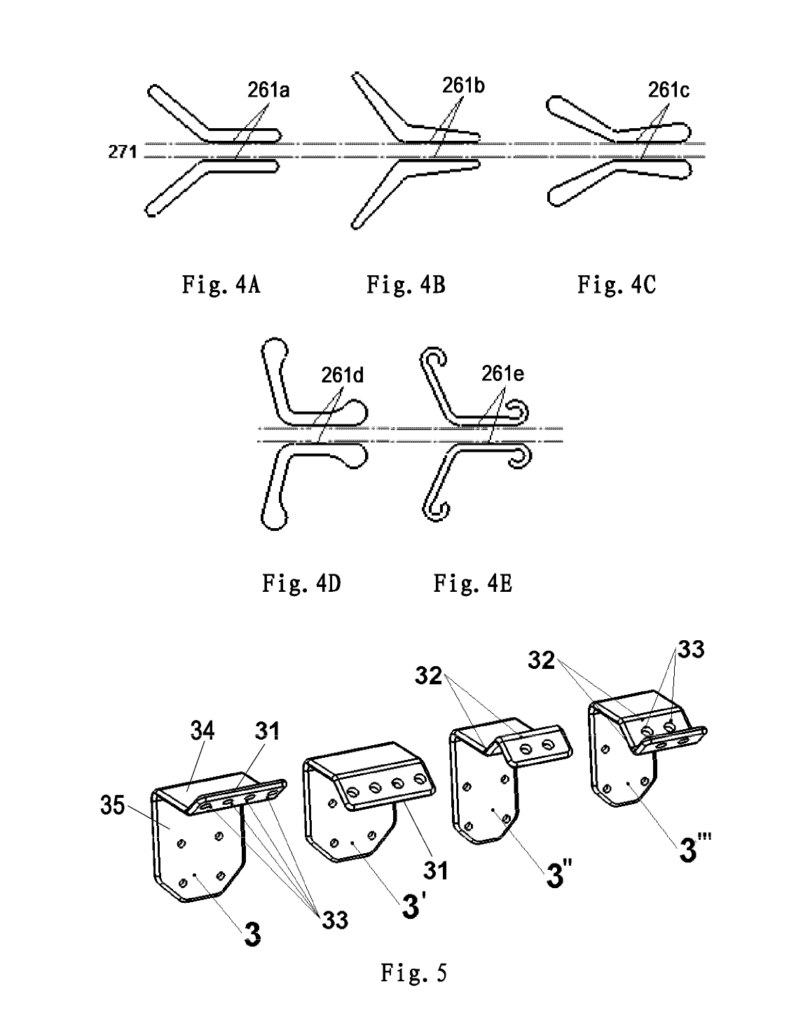

In particular implementations of the V-shape main bus-bar, a V-shaped main bus-bar may be arranged in pairs, for example, in a way of face to face at openings of the pair of the V-shaped main bus-bars, or in a way of back to back at unilateral side of the pair of the V-shaped main bus-bars, in order to achieve a better effect of transmitting power, as showed in FIGS. 3A-3E and 4A-4E. FIGS. 3A-3E schematically illustrate the face to face arrangements of pairs of the V-shaped main bus-bars illustrated in FIGS. 2A-2E, respectively, with an interval 271 between the pairs of the V-shaped main bus-bars. FIGS. 4A-4E schematically illustrate the unilateral back to back arrangements of pairs of the V-shaped main bus-bars illustrated in FIGS. 2A-2C, respectively, with an interval 271 between the respective elongated flat portions of the pairs of the V-shaped main bus-bars.

Advantageously, the V-shaped main bus-bar proposed in this disclosure has more internal and external surface for radiating heat, thus the heat accumulation existed in the hollow circular bus-bar can be effectively avoided. Moreover, the material needed to manufacture is substantially lower than the existing planar main bus-bar (e.g., the rectangular, the hollow circular main bus-bar) when experiencing the same current strength. For example, if the V-shaped main bus-bar with a certain current carrying capacity is manufactured by a Cu material, the total cost can be reduced greatly compared with the traditional main bus-bar.

The V-shaped main bus-bar also has an ability of avoiding the point discharge. At the same time, the V-shaped main bus-bar can advantageously overcome the skin effect by means of the joint area, formed as a bending line, between the two elongated flat portions.

Next, reference will be made to FIG. 5 to describe an exemplary structure of the branch bus-bars according to embodiments of the present disclosure.

In FIG. 5, perspective views of four branch bus-bars 3, 3′, 3″ and 3′″ are shown. One end of the branch bus-bars comprises one or more planar portions 34 and 35, and is provided with one or two bending segments 31 or 32, in order to be applicable to attach to the V-shaped main bus-bar at one side 21 or at two sides 21 and 22, e.g., by means of a bolt structure or welding. In implementations, the bending segments 31 and 32 may be made by means of a bending way or an extrusion molding way.

By way of example, a first portion 34 is substantially perpendicularly fixed to a second portion 35 at a transverse end thereof, as shown in FIG. 5. However, it should be noted that other angles between them except the right angle is appropriate depending on the position between a V-shaped main bus-bar and an electrical component to be connected with the branch bus-bars.

The branch bus-bars as illustrated in FIG. 5 can be regarded as the improvements of a existing planar branch bus-bar, which consists of a thickness-uniform first portion 34 and a thickness-uniform second portion 35, with further bending segment(s) being provided at the first portion. Further, those skilled in the art will understand that only one planar portion, in place of the existing planar branch bus-bar comprising two portions 34 and 35, is also feasible to connect an electrical component in some circumstances, although the existing planar branch bus-bar is shown to illustrate the proposed branch bus-bar herein.

Preferably, the bending segments 31 and 32 may be provided with several through-holes to make the fixing with the V-shaped main bus-bar more flexibly and easier, e.g., by a bolt structure. Optionally, a thread may be provided in every through-hole to improve the fixing strength. The through-holes are illustrated in FIG. 5 as holes 33. It is to be noted that the position and the number of the through-holes may depends on a particular implementation to obtain an appropriately fixed connection.

Preferably, the thickness of the bending segments 31 and 32 may be non-uniform to match the thickness of a V-shaped main bus-bar to be fixed to. In an example, the thickness of the bending segment 31 may be gradually increased outward, or the thickness of the bending segment 31 may be gradually decreased outward. In another example, the thickness of the two bending segments 32 may be gradually increased away from the joint area between the two bending segments, or the thickness of the two bending segments 32 may be gradually decreased away from the joint area between the two bending segments.

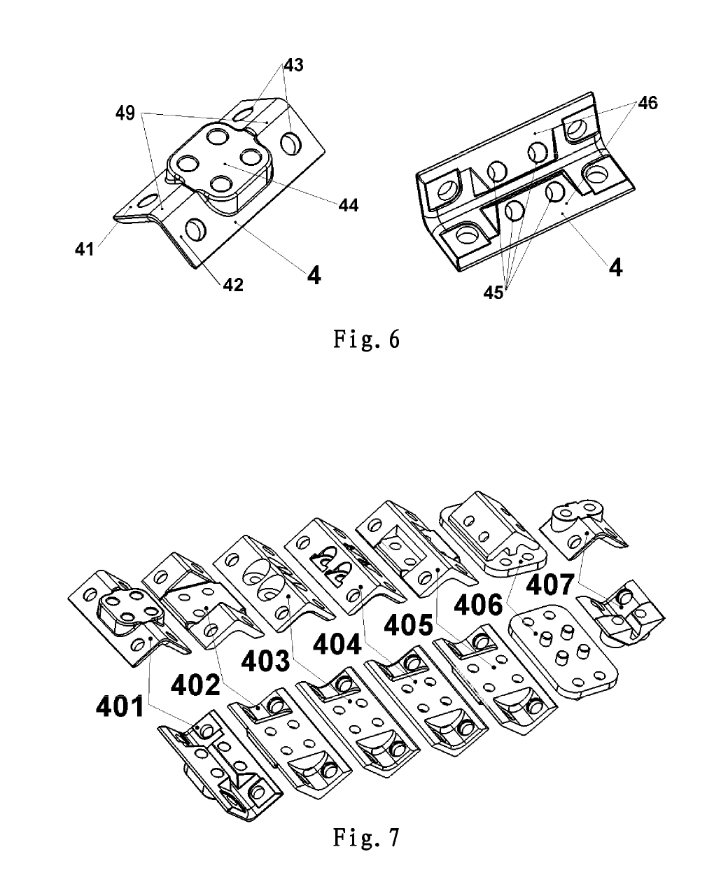

Next, reference will be made to FIG. 6 to describe an exemplary structure of a transfer connector 4 according to an embodiment of the present disclosure. The left part illustrates the transfer connector 4 seen from top to down, while the right part illustrates the transfer connector 4 seen from down to top.

In FIG. 6, a transfer connector 4 is shown. The transfer connector 4 comprises a first connector elongated flat portion 41 and a second connector elongated flat portion 42. A longitudinal side of the first connector elongated flat portion 41 and a longitudinal side of the second connector elongated flat portion 42 are arranged to be joined with each other at a predetermined angle and fixed, with an joint area 49 being formed between the first connector elongated flat portion 41 and the second connector elongated flat portion 42. The first connector elongated flat portion 41 and the second connector elongated flat portion 42 are further shaped to have at least one flat surface 46 or 44 (hereinafter referred as a attaching surface) formed between them for attaching to a flat surface of a branch bus-bar.

It is should be noted that the angle formed by the first connector elongated flat portion 41 and the second connector elongated flat portion 42 may be a sharp angle, a right angle or an obtuse angle so as to perfectly meet with a V-shaped main bus bar. Additionally, It is should be noted that the thickness of the first connector elongated flat portion 41 and the second connector elongated flat portion 42 may be uniform or non-uniform to perfectly match the thickness of the V-shaped main bus-bar to be fixed with to make the attachment between them tight.

In an implementation, the transfer connector 4 may be attached with a V-shaped main bus-bar at one end of the elongated flat portions 41 and 42, and be attached with a branch bus-bar at the attaching surface 46.

In a preferable implementation, the transfer connector 4 may be provided with several through-holes at ends of the elongated flat portions 41 and 42 to make the fixing with the V-shaped main bus-bar more flexibly and easier, e.g., by means of a bolt structure. Optionally, a thread may be provided in every through-hole. The through-holes are illustrated in FIG. 6 as holes 43. It is to be noted that the position and the number of the through-holes may depend on a particular implementation to obtain an appropriately fixed connection.

In a preferable implementation, the transfer connector 4 may be provided with several through-holes 45 at the flat surfaces 46 formed between the elongated flat portions 41 and 42 to make the fixing with a flat surface of a planar branch bus-bar more flexibly and easier, e.g., by means of a bolt structure. The through-holes are illustrated in FIG. 6 as holes 45. It is to be noted that the position and the number of the through-holes may depend on a particular implementation to obtain an appropriately fixed connection. Optionally, a thread may be provided in every through-hole.

Preferably, the opposite side of the through-holes 45 to the attaching surface 46 is a flat surface 44 (hereinafter referred as a fastening surface), which could be used with one or more fastening elements, e.g., screws and nuts for fastening a bolt structure in the through-holes, so as to make attaching between the transfer connector 4 and a planar branch bus-bar more easier.

In a preferable embodiment, similar with the FIG. 1, the joint areas 49 between the first connector elongated flat portion 41 and the second connector elongated flat portion 42 may be rounded in order to facilitate the decreasing of the skin effect and the uniformity of the electric field, which are caused by the current carried in the main bus-bar.

In another preferable embodiment, a longitudinal end of the first connector elongated flat portion 41 and a longitudinal end of the second connector elongated flat portion 42, and/or a longitudinal side opposite to the above noted joint area 49, may be rounded, in order to further facilitate the decreasing of the skin effect and the uniformity of the electric field, which are caused by the current carried in the main bus-bar.

In FIG. 6, the flat attaching surfaces 46 are formed as two parts, but it is also appreciated that the flat surfaces 46 may be formed as one whole part. Alternatively, the flat surface 44 may also be formed as several parts. In FIG. 6, the flat attaching surfaces 46 are formed inside between the first connector elongated flat portion 41 and the second connector elongated flat portion 42, but it is also appreciated that the flat attaching surface 46 may be formed outside between the first connector elongated flat portion 41 and the second connector elongated flat portion 42. Other suitable modifications of the transfer connector 4 are shown in FIG. 7 and probable modifications of it are not limited to those shown in FIG. 7, as can be appreciated by those skilled in the art.

FIG. 7 schematically illustrates perspective views of seven probable transfer connectors 401-407 according to embodiments of the present disclosure. As seen from FIG. 7, the flat fastening surface 44 can be lower than the joint area 49, e.g., in the transfer connector 402; the flat fastening surface 44 can be formed as several surface for sank holes, e.g., in the transfer connectors 403 and 404; the flat fastening surface 44 may be arranged without damaging the joint area 49, to provide more current-carrying segments, e.g., in the transfer connectors 404-406; the transfer connector may also be formed as two separate parts, e.g., in the transfer connector 407. In implementations, those skilled in the art the flat fastening surface 44 and the flat attaching surface 46 may be achieved by any appropriate machine manufacturing methods.

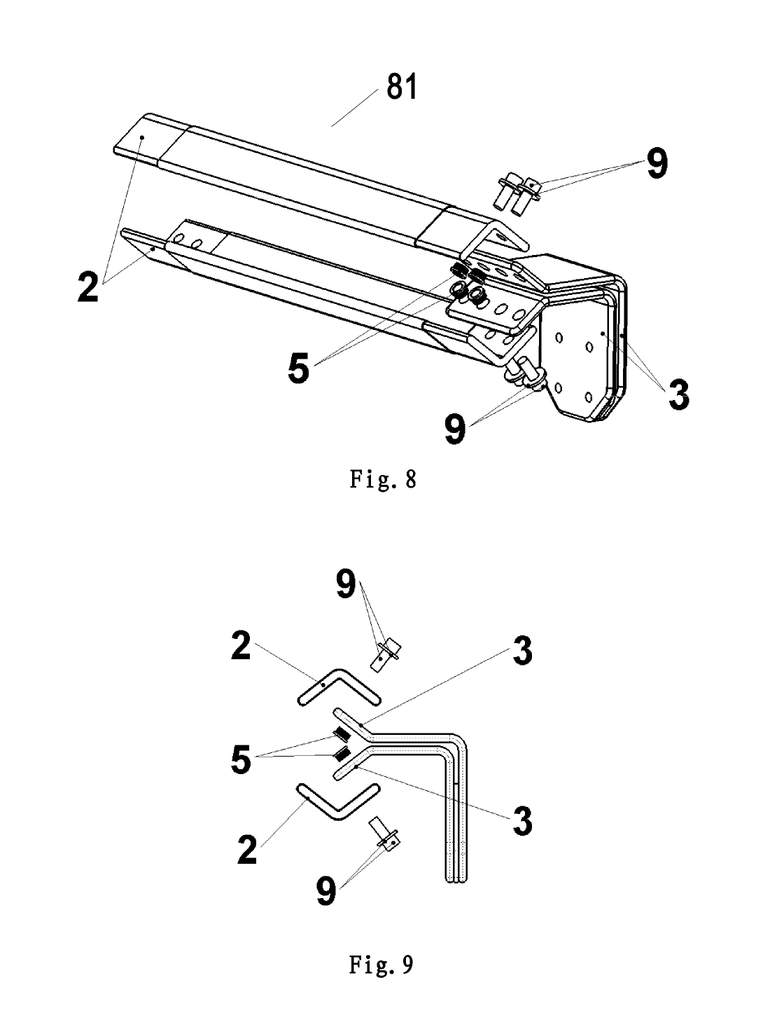

Next, reference will be made to FIGS. 8 to 11 to describe several exemplary attaching arrangements between a pair of V-shaped main bus-bar 2 and a branch bus-bar 3, according to embodiments of the present disclosure.

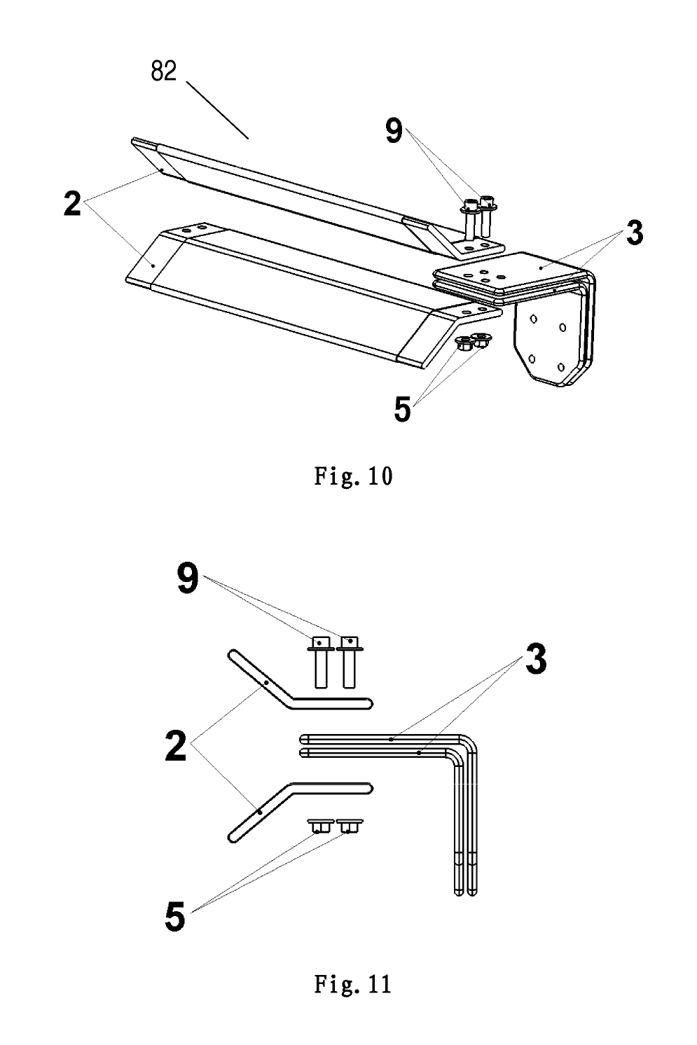

FIG. 8 schematically illustrates a perspective view of a unilateral attaching arrangement (i.e., a bus-bar assembly) between the pair of V-shaped main bus-bar 2 and the branch bus-bar 3, in a face to face way, and FIG. 9 schematically illustrates a side view of the attaching arrangement illustrated in FIG. 8. FIGS. 10 and 11 schematically illustrate a unilateral attaching arrangement between the pair of V-shaped main bus-bar 2 and the branch bus-bar 3 in a back to back way. In FIGS. 8-11, the pair of V-shaped main bus-bar 2 is fixed with the branch bus-bar 3 by means of screws 9 and nuts 5.

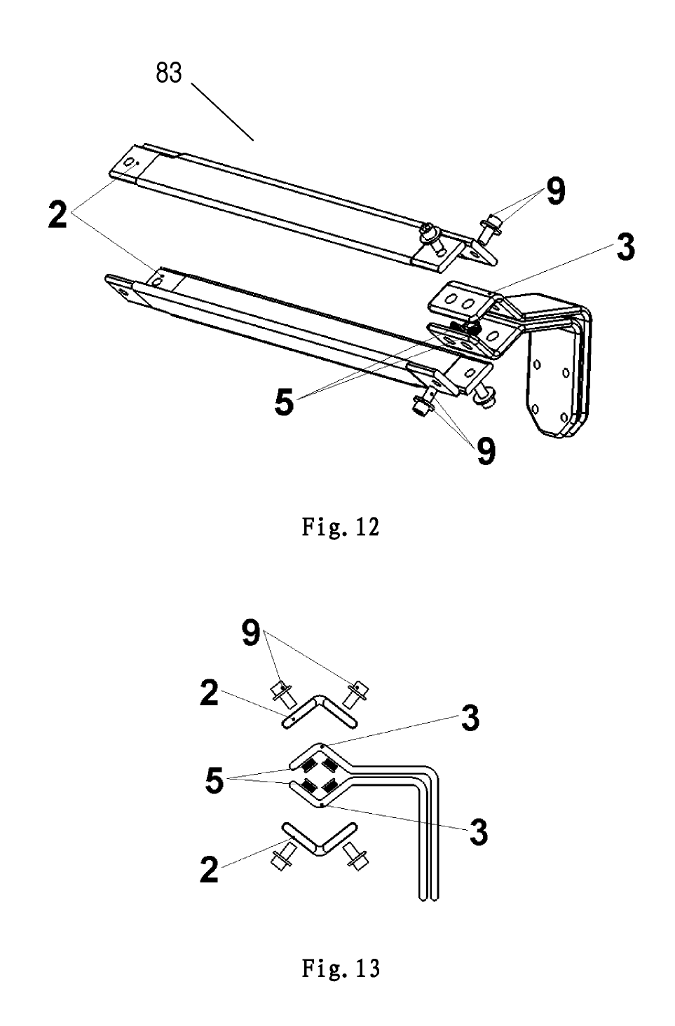

Next, reference will be made to FIGS. 12 to 13 to describe an exemplary attaching arrangement between a pair of V-shaped main bus-bar 2 and a branch bus-bar 3, according to an embodiment of the present disclosure.

FIG. 12 schematically illustrates a perspective view of a bilateral attaching arrangement between the pair of V-shaped main bus-bar 2 and the branch bus-bar 3, in a face to face way, and FIG. 13 schematically illustrates a side view of the attaching arrangement illustrated in FIG. 12. In FIGS. 12-13, the pair of V-shaped main bus-bar 2 is fixed with the branch bus-bar 3 by means of screws 9 and nuts 5.

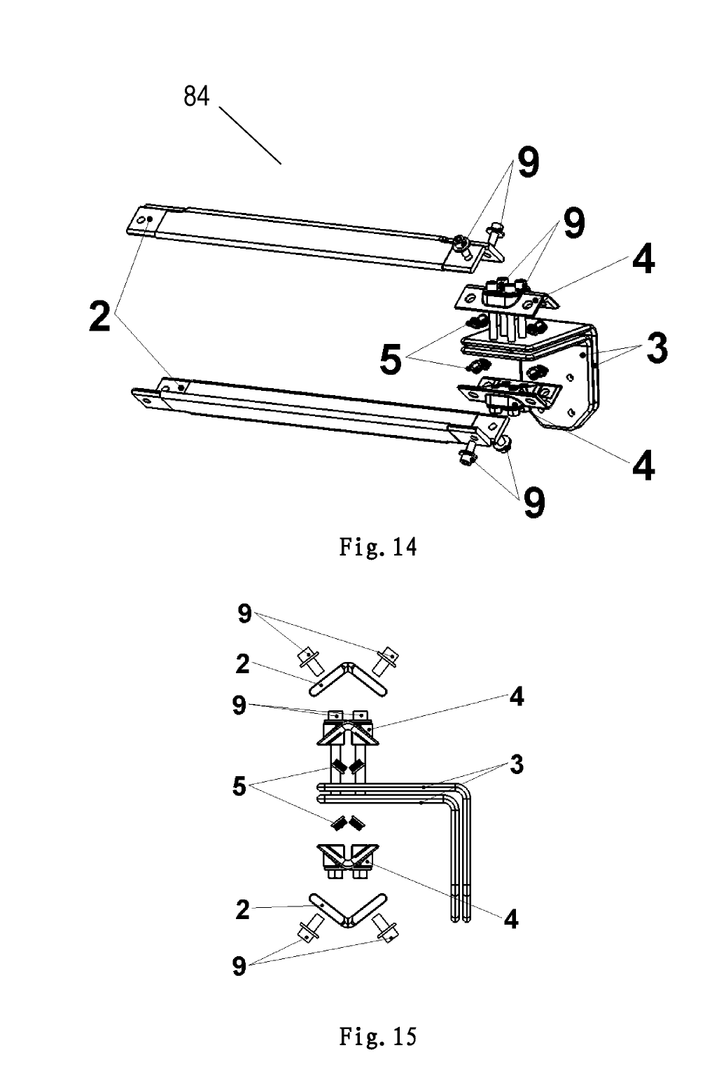

Next, reference will be made to FIGS. 14 to 15 to describe an exemplary attaching arrangement (i.e., another bus-bar assembly) between a pair of V-shaped main bus-bar 2 and a branch bus-bar 3 by means of a transfer connector 4, according to an embodiment of the present disclosure.

FIG. 14 schematically illustrates a perspective view of a bilateral attaching arrangement using a transfer connector 4 between the pair of V-shaped main bus-bar 2 and the branch bus-bar 3, in a face to face way, and FIG. 15 schematically illustrates a side view of the attaching arrangement illustrated in FIG. 14. In FIGS. 14-15, the fixing between the pair of V-shaped main bus-bar 2 and the transfer connector 4, and the fixing between transfer connector 4 and the branch bus-bar 3 is by means of screws 9 and nuts 5.

In an embodiment, the thread in the through-holes as mentioned above, e.g., holes 221, 222, 33, 43, 45, may be achieved by means of a welded nut or a wire thread. Preferably, the thread may be achieved by an embedded nut. In so doing, the mechanical strength achieved is higher than the welded nut or the wire thread.

Advantageously, the use of the branch bus-bar and the transfer connector proposed in this disclosure can make the attachment with the V-shaped main bus-bar feasibly and simply, and can make the V-shaped main bus-bar attach to the existing planar branch bus-bars.

Hereinbefore, the description has been made with reference to the exemplary structure of the V-shaped main bus-bar, the branch bus-bar and the transfer connector. However, the present disclosure is not limited thereto. In fact, there might be many variations and modifications to the embodiments of the present disclosure.

Various modifications, adaptations to the foregoing exemplary embodiments of this disclosure may become apparent to those skilled in the relevant arts in view of the foregoing description, when read in conjunction with the accompanying drawings. Any and all modifications will still fall within the scope of the non-limiting and exemplary embodiments of this disclosure. Furthermore, other embodiments of the disclosures set forth herein will come to mind to one skilled in the art to which these embodiments of the disclosure pertain having the benefit of the teachings presented in the foregoing descriptions and the associated drawings.

Therefore, it is to be understood that the embodiments of the disclosure are not to be limited to the specific embodiments disclosed and that modifications and other embodiments are intended to be included within the scope of the appended claims. Although specific terms are used herein, they are used in a generic and descriptive sense only and not for purposes of limitation.

1. A main bus-bar comprising a first elongated flat portion and a second elongated flat portion, wherein a longitudinal side of said first elongated flat portion and a longitudinal side of said second elongated flat portion are arranged to be joined with each other at a predetermined angle (α), and a thickness of each of said first elongated flat portion and said second elongated flat portion is non-uniform.

2. The main bus-bar according to claim 1, wherein the thickness of each of said first elongated flat portion and said second elongated flat portion is gradually increased or decreased away from a joint area of said first elongated flat portion and said second elongated flat portion.

3. The main bus-bar according to claim 1, wherein a width of said first elongated flat portion is equal to that of said second elongated flat portion.

4. The main bus-bar according to claim 1, wherein the other longitudinal side of at least one of the first elongated flat portion and the second elongated flat portion, opposite to the joint area, is provided with a rounded flange, a thickness of which is wider than that of the rest of the respective elongated flat portion.

5. The main bus-bar according to claim 4, wherein the rounded flange is provided with an internal groove.

6. The main bus-bar according to claim 1, wherein a longitudinal end of the first elongated flat portion and/or a longitudinal end of the second elongated flat portion are provided with one or more through-holes in which a thread is provided.

7. The main bus-bar according to claim 1, wherein a longitudinal end of the first elongated flat portion and/or a longitudinal end of the second elongated flat portion are rounded, and wherein a joint area formed between said first elongated flat portion and said second elongated flat portion is rounded.

8. The main bus-bar according to claim 1, wherein a groove is provided at an end of the joint area formed between said first elongated flat portion and said second elongated flat portion.

9. The main bus-bar according to claim 1, wherein a middle segment of said first elongated flat portion and/or said second elongated flat portion is coated with an electrical insulation composite.

10. A bus-bar assembly comprising,
a main bus-bar of including a first elongated flat portion and a second elongated flat portion, wherein a longitudinal side of the first elongated flat portion and a longitudinal side of the second elongated flat portion are arranged to be joined with each other at a predetermined angle (α), and
a branch bus-bar comprising one or more planar portions for connecting with an electrical component and one or more bending segments extended from the planar portion,
wherein at least one of the first and second elongated flat portions of the main bus-bar are arranged to be attached to the respective bending segments of the branch bus-bar.

11. The bus-bar assembly according to claim 10, wherein a thickness of each of said first elongated flat portion and said second elongated flat portion is gradually increased or decreased away from a joint area of said first elongated flat portion and said second elongated flat portion.

12. The bus-bar assembly according to claim 11, wherein,
a longitudinal end of the first elongated flat portion and/or a longitudinal end of the second elongated flat portion are provided with one or more first through-holes in which a thread is provided,
said bending segments are provided with one or more second through-holes with a thread therein, and
the respective elongated flat portion of the main bus-bar is attached to the respective bending segment of the branch bus-bar via the respective first and second through-holes by means of a bolt structure.

13. A bus-bar system comprising two bus-bar assemblies according to claim 10, wherein at least one of the first elongated flat portion and the second elongated flat portion of the main bus-bar of the first bus-bar assembly is arranged to be parallel to respective one of the first elongated flat portion and the second elongated flat portion of the main bus-bar of the second bus-bar assembly.

14. A bus-bar assembly comprising,
a main bus-bar comprising a first elongated flat portion and a second elongated flat portion, wherein a longitudinal side of the first elongated flat portion and a longitudinal side of the second elongated flat portion are arranged to be joined with each other at a determined angle (α),
a branch bus-bar comprising two or more planar portions, and
a transfer connector for connecting the main bus-bar with the branch bus-bar, wherein the transfer connector comprises a first connector elongated flat portion and a second connector elongated flat portion, a longitudinal side of the first connector elongated flat portion and a longitudinal side of the second connector elongated flat portion are arranged to be joined with each other at a predetermined angle, and one flat surface is provided between the first connector elongated flat portion and the second connector elongated flat portion,
wherein the first elongated flat portion of the main bus-bar is arranged to be attached to the first connector elongated flat portion,
the second elongated flat portion of the main bus-bar is arranged to be attached to the second connector elongated flat portion, and
one of the two or more planar portions of the branch bus-bar is adapted to be connected to an electrical component, and the other of said two or more planar portions is arranged to be attached to the one flat surface.

15. The bus-bar assembly according to claim 14, wherein said one flat surface is provided with one or more first embedded through-holes with a thread therein, and a side of said one or more first embedded through-holes opposite to said one flat surface is another flat surface.

16. The bus-bar assembly according to claim 15, wherein the another flat surface is lower than a joint area of the first connector elongated flat portion (41) and the second connector elongated flat portion.

17. The bus-bar assembly according to claim 14, wherein
a longitudinal end of the first elongated flat portion and/or a longitudinal end of the second elongated flat portion are provided with one or more second embedded through-holes in which a thread is provided,
a longitudinal end of the first connector elongated flat portion and/or a longitudinal end of the second connector elongated flat portion are provided with one or more third embedded through-holes in which a thread is provided,
the respective elongated flat portion of the main bus-bar is attached to the respective connector elongated flat portion of the transfer connector via the second and third embedded through-holes by a bolt structure.

18. The bus-bar assembly according to claim 17, wherein
the one flat surface is attached to the other portion of said two or more planar portions via said first through-holes and through-holes in the other portion by means of a bolt structure.

19. A bus-bar system comprising two bus-bar assemblies according to claim 14, wherein at least one of the first elongated flat portion and the second elongated flat portion of the main bus-bar of the first bus-bar assembly is arranged to be parallel to respective one of the first elongated flat portion and the second elongated flat portion of the main bus-bar of the second bus-bar assembly.

20. A transfer connector for connecting a main bus-bar with a branch bus-bar, comprising a first connector elongated flat portion and a second connector elongated flat portion,
wherein a longitudinal side of the first connector elongated flat portion and a longitudinal side of the second connector elongated flat portion are arranged to be joined with each other at a predetermined angle,
the first connector elongated flat portion is adapted to be attached to a first elongated flat portion of a main bus-bar, and the second connector elongated flat portion is adapted to be attached to a second elongated flat portion of the main bus-bar, and
one flat surface is provided between the first connector elongated flat portion and the second connector elongated flat portion, and is adapted to be attached to a branch bus-bar.
